(19) United States
(12) Patent Application Publication
(10) Pub. No.: US 2011/0066945 A1
(43) Pub. Date: Mar. 17, 2011

(54) Video Greeting Cards

(76) Inventors: Yuk-Shan Lee, Hong Kong (HK); Zev Perlmutter, Tel Aviv (IL)

(21) Appl. No.: 12/558,863

(22) Filed: Sep. 14, 2009

(51) Int. Cl. G06F 3/01; H04N 5/93

(52) U.S. Cl. 715/719; 715/723

(57) ABSTRACT

A multimedia device comprising: a recording unit comprising a camera and a microphone, allowing users to record video messages; a contributor chain module arranged to organize the recordings corresponding to the order of video messages contributed by each user; a user interface allowing users to input additional content and edit the video messages; a communication unit allowing input and output of multimedia content; a managing unit comprising a power source, a processor, a memory and an application, arranged to save, manage and allow editing of multimedia content, so as to produce an integrated multimedia content from the abovementioned content; and a playback unit comprising a display and a speaker, arranged to allow reproducing the integrated multimedia content. One multimedia device is arranged to allow different users to sequentially save and edit multimedia content, to reproduce the integrated multimedia content and to allow associating different parts of the integrated multimedia content with individual users.

### BACKGROUND

1. Technical Field

The present invention relates to the field of multimedia devices, and more particularly, to an editable multimedia card.

2. Discussion of Related Art

Greeting cards are important means of social communication, but are usually difficult to customize. Especially customization by a group of people, for example, in case of a birthday greeting cards, requires using pens and paper in the traditional ways, or attaching an additional media for, e.g., home made video films.

### BRIEF SUMMARY

Embodiments of the present invention provide a multimedia device comprising: a recording unit comprising a camera and a microphone, arranged to allow users to record video messages; a contributor chain module arranged to organize the recordings corresponding to the order of video messages contributed by each user; a user interface arranged to allow users to input additional content and edit the video messages; a communication unit arranged to allow input and output of multimedia content; a managing unit comprising a power source, a processor, a memory and an application, arranged to save, manage and allow editing of multimedia content, so as to produce an integrated multimedia content comprising the video messages, additional content and inputted multimedia content; and a playback unit comprising a display and a speaker, arranged to allow reproducing the integrated multimedia content. One multimedia device is arranged to allow different users to sequentially save and edit multimedia content, to reproduce the integrated multimedia content and to allow associating different parts of the integrated multimedia content with individual users.

Accordingly, according to an aspect of the present invention, there is provided a multimedia device, wherein the managing unit further comprises a video format manager arranged to decode and convert video formats of the video messages to a predefined format.

Accordingly, according to another aspect of the present invention, there is provided a multimedia device, wherein the user interface comprises an electronic pen unit arranged to allow generating hand written notes relating to parts of the multimedia content, and wherein the managing unit is arranged to integrate the generated notes into the integrated multimedia content.

Accordingly, according to yet another aspect of the present invention, there is provided a multimedia device, wherein the integrated multimedia content is integrated so as to allow the identification of a generation timing for each video message, additional content and inputted multimedia content.

Accordingly, according to still another aspect of the present invention, there is provided a multimedia device, wherein the multimedia device is encased so as to be used as a personalized greeting card, a personalized video chain letter or a personalized digital video diary recording environment events and editing them online or directly on card.

Embodiments of the present invention provide a method of producing a greeting card, chain letter, or a video diary enhanced with multimedia content. One method comprises: recording a plurality of video messages by a plurality of users using the same recording means that are integrated in the greeting card; associating each video message with a corresponding user which was identified before or during the recording of the video message; editing the video messages using editing means that are integrated in the greeting card or using online web site editing tools; arranging the video messages to an integrated multimedia content so as to allow sequence of video messages ordered and differentiated according to associated users; and reproducing the integrated multimedia content by playback means that are integrated in the greeting card.

Accordingly, according to an aspect of the present invention, there is provided a method, further comprising: inputting notes related to the video messages electronically; and integrating the notes into the integrated multimedia content so as to maintain the relation of the notes to the video messages.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIGS. 1 and 2 are high level schematic block diagrams illustrating a multimedia device and an embodiment thereof as an editable multimedia card, according to some embodiments of the invention;

FIG. 3 is a schematic illustration of the editable multimedia card as a greeting card, a chain letter or a video diary, according to some embodiments of the invention; and

FIGS. 4 and 5 are high level flowcharts illustrating a method of producing a greeting card enhanced with multimedia content, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

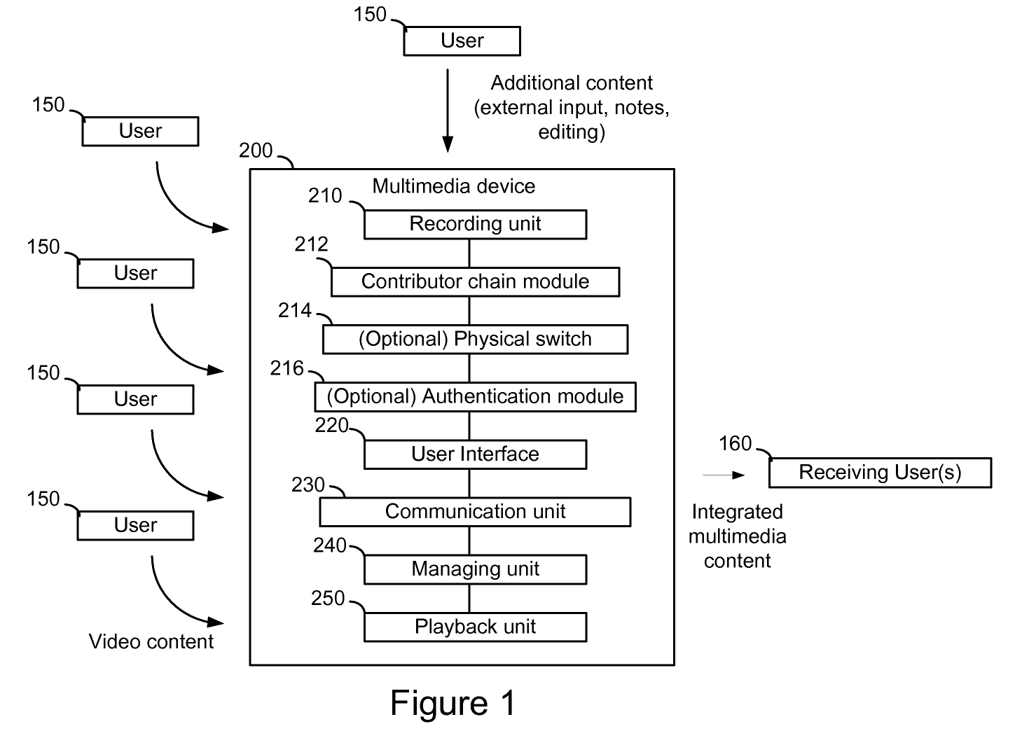

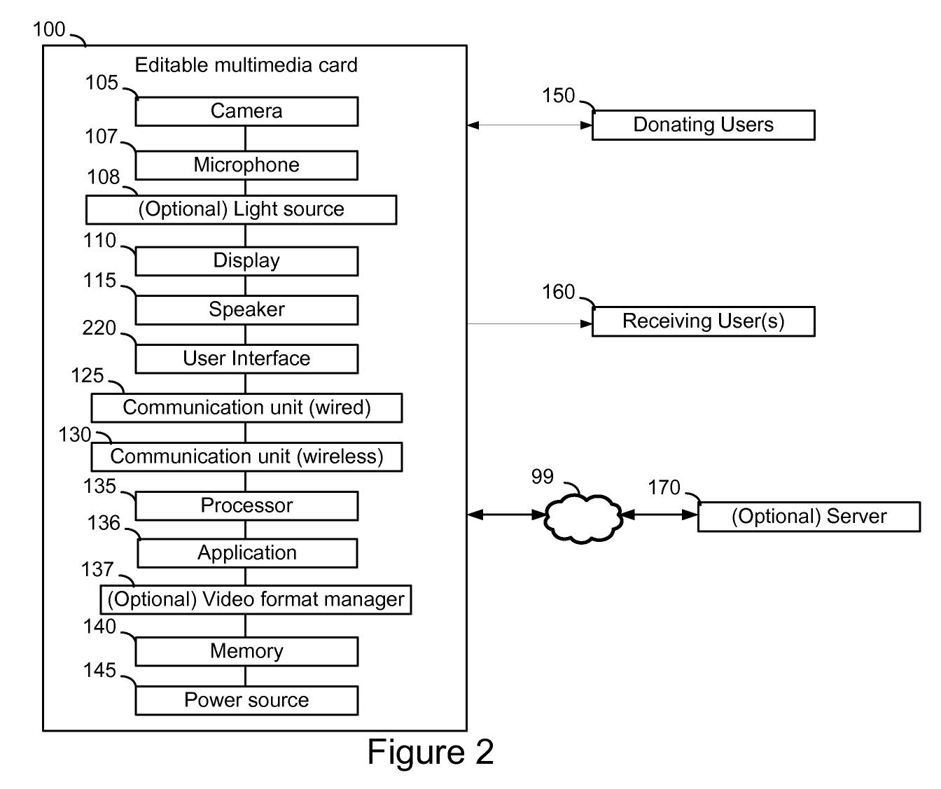

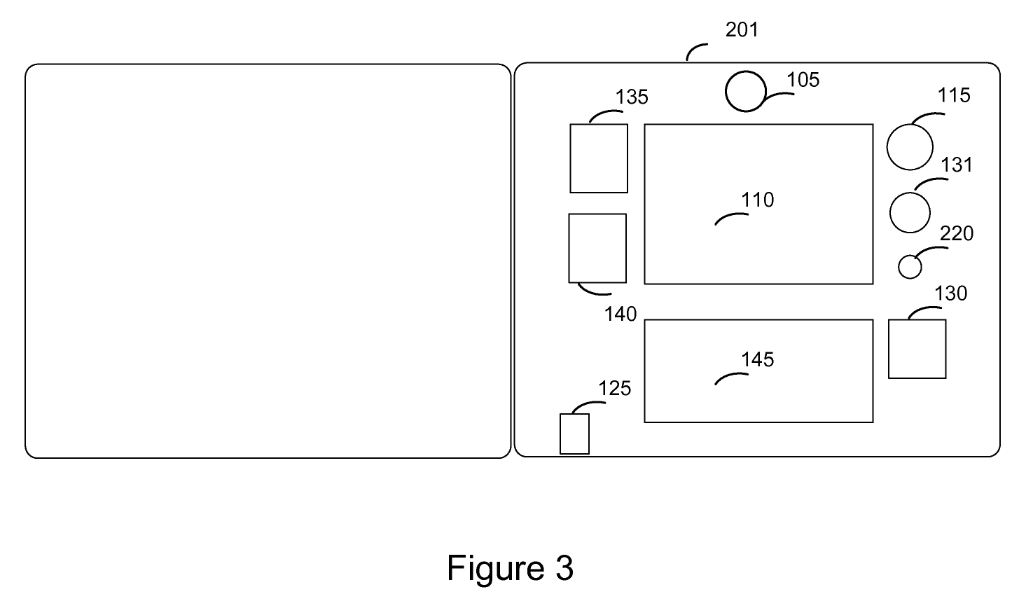

FIGS. 1 and 2 are high level schematic block diagrams illustrating a multimedia device 200 and an embodiment thereof as an editable multimedia card 100, according to some embodiments of the invention. FIG. 3 is a schematic illustration of editable multimedia card 100 as a greeting card, a chain letter or a video diary, according to some embodiments of the invention.

In embodiments, multimedia device 200 comprises a recording unit 210 comprising, e.g., a camera 105 and a microphone 107, arranged to allow users 150 to record video messages. Recording unit 210 may further comprise a light source 108 and be arranged to allow recording the video messages in the dark. Camera 105 may be of CCD, CMOS or any other type.

In embodiments, multimedia device 200 comprises a contributor chain module 212 arranged to organize the recordings corresponding to the order of video messages and an order of users 150 and corresponding video messages contributed by each user 150. Multimedia device 200 may further comprise a physical switch 214 associated with contributor chain module 212. Physical switch 214 may be arranged to be activated upon each change of user 150 and enable contributor chain module 212 to relate the corresponding video messages to the recording users 150. Multimedia device 200 may further comprise an authentication module 216 connected to contributor chain module 212 and arranged to authenticate each user 150. Alternatively or complementarily, authentication module 216 may be associated with or replace by an authentication module on remote server 170.

In embodiments, multimedia device 200 comprises a user interface 220 arranged to allow user 150 to input additional content and edit the video message. User interface 220 may comprise an electronic pen unit (not shown) arranged to allow generating hand written notes relating to parts of the multimedia content.

According to some embodiments of the invention, user interface 220 may comprise an on/off button arranged to activate multimedia device 200 upon pushing the button or upon opening multimedia device 200 in form of a foldable card.

In embodiments, multimedia device 200 comprises a communication unit 230 arranged to allow input and output of multimedia content. Communication unit 230 may comprise a wired communication unit 125 (e.g., a USB socket and cable, separated, integrated or in socket form) and a wireless communication unit 130 such as one operable with BlueTooth, WiFi, optical communication, cellular network (e.g., per SMS or MMS) etc. Inputted multimedia content may comprise templates for recording and editing multimedia content. Communication unit 230 may comprise a cellular communication module 131 (see FIG. 3) such as utilizing GSM (Global System for Mobile communications).

According to some embodiments of the invention, managing unit 240 may communicate via communication unit 230 with a remote server 170 over a wired or wireless communication link 99. Server 170 may provide templates and additional multimedia content to be integrated into the integrated multimedia content, allow user 150 to add content via server 170, user 160 to receive the integrated multimedia content via server 170, and other users to view, vote and co-edit the multimedia content.

In embodiments, multimedia device 200 comprises a managing unit 240 comprising a power source 145, a processor 135, a memory 140 and an application 136, arranged to save, manage and allow editing of multimedia content, so as to produce an integrated multimedia content comprising the video messages, additional content and inputted multimedia content. Managing unit 240 may be arranged to integrate notes generated by the electronic pen unit into the integrated multimedia content. For example, notes relating to specific parts of the multimedia content may be visually integrated as parts thereof in the appropriate timing. Memory 140 may comprise a flash memory, a detachable memory card or a combination thereof. Power source 145 may comprise batteries (such as button cell batteries or alkaline batteries), rechargeable cell batteries or a combination thereof (the non-rechargeable batteries serving as backup).

According to some embodiments of the invention, managing unit 240 is arranged, and the integrated multimedia content is integrated such as, to allow re-editing the integrated multimedia content. For example, receiving user 160 may re-edit the integrated multimedia content, add content and generate a new integrated multimedia content.

According to some embodiments of the invention, multimedia device 200 may be operated by a main user or an “event director” that may choose a group of people that can have a code or authorization to add their messages to multimedia device 200 physically, or online with editing tools. After all messages have been added, the main user may collect the video messages from his group, send or edit them directly online or on multimedia device 200. The main user may he manage the messages and direct them over e.g., the Internet via server 170.

According to some embodiments of the invention, multimedia device 200 may be used as a chain letter (users 150 sending it to each other sequentially) or as a video dairy (a user recording messages through time, like in a diary). These may as well be edited directly on multimedia device 200 or online via server 170.

According to some embodiments of the invention, the power consumption of multimedia device 200 may be optimize to allow recording a predefined number of video messages and editing in respect to the capacity of power source 145 and to the power consumption patterns of display 110.

According to some embodiments of the invention, managing unit 240 may further comprise a video format manager 137 arranged to decode and convert video formats of the video messages to a predefined format. The integrated multimedia content is integrated so as to allow the identification of parameters such as a source or a generation timing for each video message, additional content and inputted multimedia content. Video format manager 137 may be arranged to receive a large variety of file formats (audio, graphic, image, video, multimedia) and make them available for integration in the multimedia content. Video format manager 137 may be further arranged to allow outputting the integrated multimedia content in various formats. Multimedia device 200 may use a designated multimedia format and video format manager 137 may be arranged to convert other format to and from the designated multimedia format. In particular, the designated multimedia format may comprise identification possibilities for individual content elements that are integrated, and allow their designation or marking.

In embodiments, multimedia device 200 comprises a playback unit 250 comprising a display 110 and a speaker 115, arranged to allow reproducing the integrated multimedia content. Display 110 may comprise any of various liquid crystal displays (LCD) or other types such as a touch screen (partly integrated within user interface 220), or various organic light emitting diode (OLED) displays. Processor 135 may comprise a 16-bit central processing unit (CPU) arranged to control display 110 and speaker 115.

According to some embodiments of the invention, multimedia device 200 is arranged to allow users 150 to sequentially save and edit multimedia content, to reproduce the integrated multimedia content and to allow associating different parts of the integrated multimedia content with individual users 150. Multimedia device 200 may be given to a receiving user 160 as a present, and encased so as to be used as a personalized greeting card. The encased multimedia device 200 may be designed appropriately, e.g., after various themes. For example, a case 201 (FIG. 3) may comprise plastic, metal, paper, wood or their combinations and be adapted to greeting event such as birthdays, anniversaries, holidays, weddings or other special events.

According to some embodiments of the invention, multimedia device 200 may be used as a promotional card, allowing clients or workers to participate in its editing. In such cases it may comprise search and text editing tools. Multimedia device 200 may be used as a story teller book, allow parents to document themselves reading a book, or allowing the production of multimedia content to accompany story that is printed on multimedia device 200. Multimedia device 200 may comprise several pages, each with its own playback unit 250 and user interface 220 to allow producing varying integrated multimedia content on each page. Multimedia device 200 may incorporate video games as part of the integrated multimedia content.

According to some embodiments of the invention, multimedia device 200 may allow detailed differentiation among source, timing and types of elements composing the integrated multimedia content. Contributor chain module 212 in cooperation with physical switch 214 may be used to differentiate among users 150 and their contributions to the integrated multimedia content. For example, multimedia device 200 may passed among guests of an event, and each guest is allowed to leave a video message for the host (e.g., in a wedding).

According to some embodiments of the invention, multimedia device 200 may further comprise various covers (not shown), attachable upon case 201, that allow variable use of multimedia device 200. The covers may be of paper, plastic, fabric-all printed with decorations. These may be sold in packs or as separate units with multimedia device 200 as a basic core device. Users 150 may choose the cover as skin according to style or occasion (birthday, Xmas, etc) and connect it to multimedia device 200 by Velcro or zipper, snap etc. The cover make multimedia device 200 customizable and reusable, e.g., one may reuse received video greeting cards. The covers may be printable by users 150 and thus further customizable.

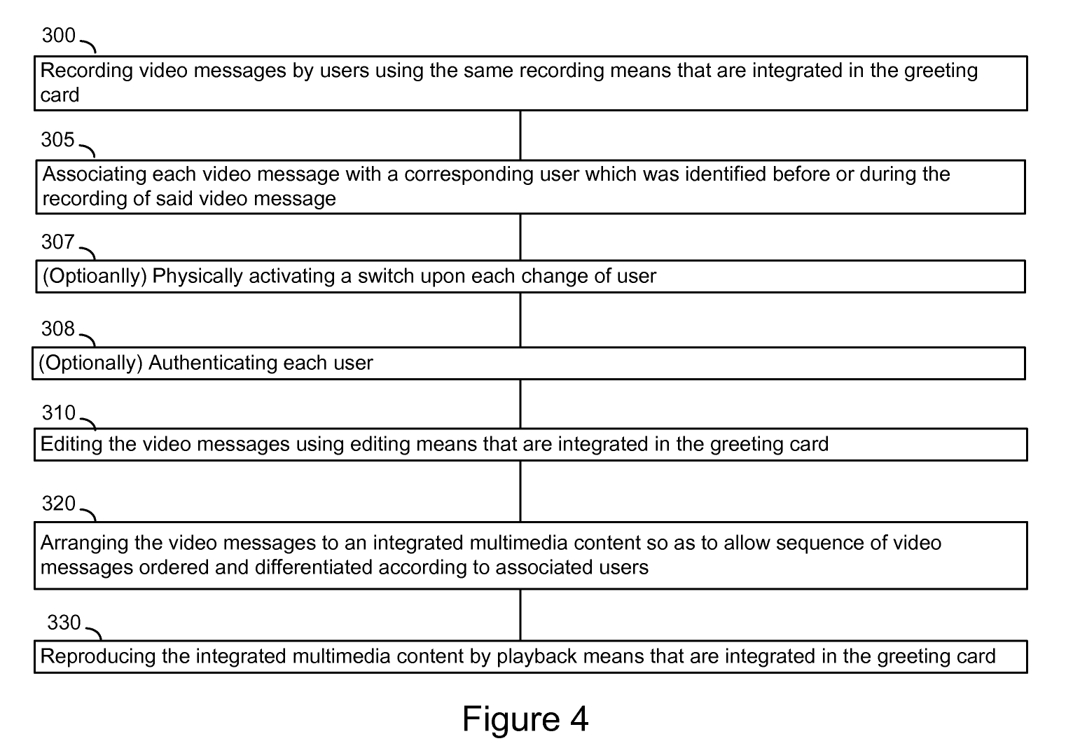

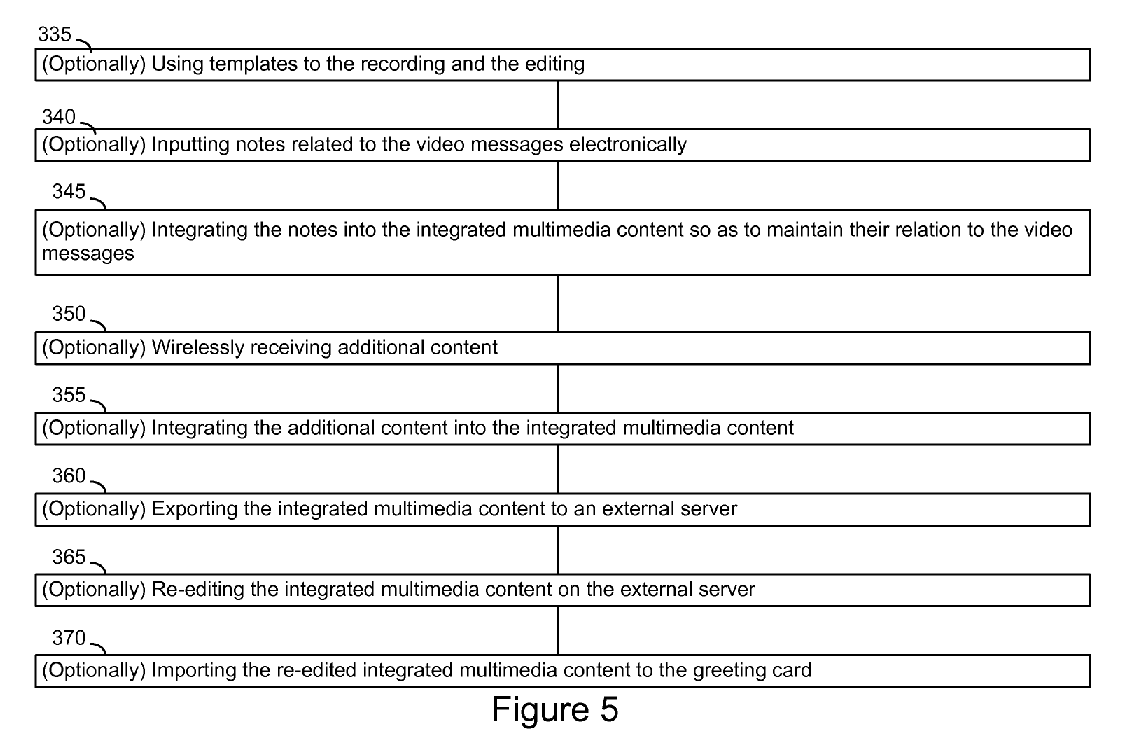

FIGS. 4 and 5 are high level flowcharts illustrating a method of producing a greeting card enhanced with multimedia content, according to some embodiments of the invention. The method comprises the following stages: recording video messages by users using the same recording means that are integrated in the greeting card (stage 300); associating each video message with a corresponding user which was identified before or during the recording of the video message (stage 305); editing the video messages using editing means that are integrated in the greeting card (stage 310), or using online web site editing tools; arranging the video messages to an integrated multimedia content so as to allow sequence of video messages ordered and differentiated according to associated users (stage 320); and reproducing the integrated multimedia content (stage 330) by playback means that are integrated in the greeting card.

According to some embodiments of the invention, the method may further comprise physically activating a switch upon each change of user (stage 307). Associating each user with the corresponding video message (stage 305) may utilize the switch activation (stage 307) in order to differentiate among users. The method may further comprise authenticating each user (stage 308) as part of this differentiation.

According to some embodiments of the invention, the method may further comprise using templates to the recording and the editing (stage 335). The templates may be customized according to the type of greeting card used.

According to some embodiments of the invention, the method may further comprise inputting notes related to the video messages electronically (stage 340); and integrating the notes into the integrated multimedia content (stage 345) so as to maintain the relation of the notes to the video messages. In the integrated multimedia content, single notes may be related to particular timings in the corresponding video message and to related to a specific recording user.

According to some embodiments of the invention, the method may further comprise wirelessly receiving additional content (stage 350); and integrating the additional content into the integrated multimedia content (stage 355).

According to some embodiments of the invention, the method may further comprise exporting the integrated multimedia content to an external server (stage 360); re-editing the integrated multimedia content on the external server (stage 365); and importing the re-edited integrated multimedia content to the greeting card (stage 370).

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A multimedia device comprising:
a recording unit comprising a camera and a microphone, arranged to allow a plurality of users to record a plurality of video messages;
a contributor chain module arranged to organize the recordings corresponding to an order of video messages contributed by each user;
a user interface arranged to allow the users to input additional content and edit the video messages;
a communication unit arranged to allow input and output of multimedia content;
a managing unit comprising a power source, a processor, a memory and an application, arranged to save, manage and allow editing of multimedia content, so as to produce an integrated multimedia content comprising the video messages, additional content and inputted multimedia content; and
a playback unit comprising a display and a speaker, arranged to allow reproducing the integrated multimedia content,
wherein the multimedia device is arranged to allow different users to sequentially save and edit multimedia content, to reproduce the integrated multimedia content and to allow associating different parts of the integrated multimedia content with individual users.

2. The multimedia device of claim 1, further comprising a physical switch associated with the contributor chain module, the physical switch arranged to be activated upon each change of user and enable the contributor chain module to relate the corresponding video messages to the recording users.

3. The multimedia device of claim 1, further comprising an authentication module connected to the contributor chain module and arranged to authenticate each user.

4. The multimedia device of claim 1, wherein the recording unit further comprises a light source and is arranged to allow recording the video messages in the dark.

5. The multimedia device of claim 1, wherein the managing unit further comprises a video format manager arranged to decode and convert video formats of the video messages to a predefined format.

6. The multimedia device of claim 1, wherein the user interface comprises an electronic pen unit arranged to allow generating hand written notes relating to parts of the multimedia content, and wherein the managing unit is arranged to integrate the generated notes into the integrated multimedia content.

7. The multimedia device of claim 1, wherein the integrated multimedia content is integrated so as to allow the identification of a source for each video message, additional content and inputted multimedia content.

8. The multimedia device of claim 1, wherein the integrated multimedia content is integrated so as to allow the identification of a generation timing for each video message, additional content and inputted multimedia content.

9. The multimedia device of claim 1, wherein the managing unit is arranged, and the integrated multimedia content is integrated such as, to allow re-editing the integrated multimedia content.

10. The multimedia device of claim 1, wherein inputted multimedia content comprises templates for recording and editing multimedia content.

11. The multimedia device of claim 1, wherein the multimedia device is encased so as to be used as a personalized greeting card.

12. The multimedia device of claim 11, further comprising a plurality of covers attachable upon the multimedia device and customizable.

13. A method of producing a greeting card enhanced with multimedia content, comprising:
recording a plurality of video messages by a plurality of users using a same recording means that is integrated in the greeting card;
associating each video message with a corresponding user which was identified before or during the recording of the video message;
editing the video messages using editing means that are integrated in the greeting card;
arranging the video messages to an integrated multimedia content so as to allow sequence of video messages ordered and differentiated according to associated users; and
reproducing the integrated multimedia content by playback means that are integrated in the greeting card.

14. The method of claim 13, further comprising physically activating a switch upon each change of user, and wherein the associating each user with the corresponding video message utilizes the switch activation.

15. The method of claim 13, further comprising authenticating each user.

16. The method of claim 13, further comprising using templates to the recording and the editing.

17. The method of claim 13, further comprising:
inputting notes related to the video messages electronically; and
integrating the notes into the integrated multimedia content so as to maintain the relation of the notes to the video messages.

18. The method of claim 13, further comprising:
wirelessly receiving additional content; and
integrating the additional content into the integrated multimedia content.

19. The method of claim 13, further comprising:
exporting the integrated multimedia content to an external server;
re-editing the integrated multimedia content on the external server; and
importing the re-edited integrated multimedia content to the greeting card.
